(19) United States
(12) Patent Application Publication
(10) Pub. No.: US 2017/0018039 A1
(43) Pub. Date: Jan. 19, 2017

(54) METHOD AND SYSTEM FOR ESTIMATING PRODUCTION OF AN ENERGY COMMODITY BY A SELECTED PRODUCER

(71) Applicant: Genscape Intangible Holding, Inc., Louisville, KY (US)

(72) Inventors: Randall L. Collum, JR., Richmond, TX (US); Josef W. Spalenka, Louisville, KY (US); Deirdre Alphenaar, Prospect, KY (US)

(21) Appl. No.: 15/210,940

(22) Filed: Jul. 15, 2016

Related U.S. Application Data
(60) Provisional application No. 62/194,014, filed on Jul. 17, 2015.

(51) Int. Cl. G06Q 50/06; G06Q 30/02

(52) U.S. Cl. CPC G06Q 50/06; G06Q 30/0205

(57) ABSTRACT

A method and system for estimating production of an energy commodity for a selected producer includes the steps of: identifying a producer-associated region, including an identification of transaction points within the producer-associated region; storing transfer datasets associated with the identified transaction points, such as natural gas pipeline nominations or crude oil transfer datasets, in a database; choosing a subset of transfer datasets from the database; determining an aggregated value for overall production activity from the subset of transfer datasets; and correlating the aggregated value for overall production activity against historical production data to establish a model for estimating production of the energy commodity by the producer. When transfer datasets are subsequently received, those transfer datasets are input into the model to estimate production of the energy commodity by the producer. The estimated production of the energy commodity by the producer is then reported to a market participant.

### CROSS-REFERENCE TO RELATED APPLICATIONS

The present application claims priority to U.S. Patent Application Ser. No. 62/194,014 filed on Jul. 17, 2015, which is incorporated herein by reference.

### BACKGROUND OF THE INVENTION

The present invention relates to the production of an energy commodity, such as crude oil or natural gas.

In producing crude oil and natural gas, oil wells and/or gas wells are constructed throughout a particular geographic region, and the crude oil and/or natural gas captured by those wells is transferred through a complex network of pipelines, pipeline metering stations, processing facilities, storage facilities, interconnections, and other infrastructure. Although information about the production of crude oil and natural gas is very valuable to market participants, in most cases, production data is not immediately available, but is made available a few weeks or months after production. However, certain data is available on a more immediate basis, including; (i) daily natural gas pipeline nominations, which are day-ahead contracted flows of physical gas to be delivered to transaction points in a pipeline network; and (ii) daily crude oil transfer datasets, which are typically real-time measurements of physical crude oil flows or transfers by rail or pipeline.

It thus would be advantageous to use immediately available natural gas and/or crude oil data to estimate commodity production for a selected producer.

### SUMMARY OF THE INVENTION

The present invention is a method for estimating (and forecasting) production of an energy commodity (such as crude oil or natural gas) by a selected producer based on an optimized model of commodity transfer activity for the same geographic region in which the production assets of the selected producer are located.

An exemplary implementation of the method of the present invention commences with the selection of a producer of interest. Once the producer has been selected, the producer-associated region (or regions) is identified, including an identification of transaction points within the producer-associated region. This identification of a producer-associated region (or regions) can be carried out by automatically or manually associating certain production assets and infrastructure with specific producer-owned networks. After a particular producer-associated region has been identified, and all available transaction points have been identified for the transfer of a commodity from the particular producer-associated region, a value for overall production activity (for example, crude oil production or natural gas production) for the region is determined from a subset of selected transfer datasets associated with the transaction points.

In the case of natural gas production, the subset of selected transfer datasets are comprised of daily natural gas pipeline nominations from a set of natural gas pipelines. Such nominations are not real-time measurements of physical natural gas flows. Rather, they are day-ahead or same-day contracted flows of physical gas to be delivered to transaction points in a pipeline network. With respect to the selection of the daily natural gas pipeline nominations to be included in the subset, the objective is to select those nominations at specific transaction points that are most closely correlated with a producer's gas and/or oil production.

In the case of crude oil production, the subset of selected transfer datasets are comprised of daily crude oil transfer datasets. Such daily crude oil transfer datasets are typically real-time measurements of physical crude oil flows or transfers by pipeline or rail. With respect to the selection of the daily crude oil transfer datasets to be included in the subset, the objective is to select those datasets at specific transaction points that are most closely correlated with a producer's gas and/or oil production.

The next step is to calibrate the aggregated values of overall production activity within the subset against publicly available historical production data. In most cases, historical production data is not immediately available, but is made available a few weeks or months after production and is commonly reported in terms of an average oil production value for each month (or quarter) in units of barrels per day for crude oil production and of million metric cubic feet per day (MMcfd) for gas production. In any event, the result is a model for estimating production of the energy commodity by the selected producer, i.e., a producer production model.

Once the producer production model has been established and optimized for a producer, whether based on natural gas pipeline nominations or crude oil transfer datasets, the producer production model is then stored in a memory component of a computer, and, as natural gas pipeline nominations or crude oil transfer datasets are received for a particular day, those natural gas pipeline nominations or crude oil transfer datasets are input into the producer production model to estimate producer-specific production (e.g., gas and/or oil production). The estimated production is then reported to market participants and other interested parties, e.g., third parties who would not ordinarily have ready access to such information.

The above-described operational and computational steps of this method are preferably achieved through the use of a digital computer program (i.e., computer-readable instructions executed by a processor of a computer) that includes appropriate modules for executing the requisite instructions (which are stored in a memory component). Thus, an exemplary system for estimating production of an energy commodity in accordance with the present invention includes: (a) an information receiving module for receiving an input from a user as to a selection of a producer; (b) an identification module for identifying a producer-associated region and transaction points within the producer-associated region; (c) a data receiving module for receiving transfer datasets associated with the identified transaction points and storing those transfer datasets in the database; (d) an analysis module for (i) choosing a subset of transfer datasets from the database, (ii) determining an aggregated value for overall production activity from the subset of transfer datasets for a predetermined time period, (iii) correlating the aggregated value for overall production activity for the predetermined time period against historical production data to establish a model for estimating production of the energy commodity by the producer, and (iv) applying the model to subsequently received transfer datasets for a particular time period to estimate production of the energy commodity by the producer for the particular time period; and (e) a reporting module for reporting the estimated production of the energy commodity by the producer for the particular time period to a market participant.

### DESCRIPTION OF THE DRAWINGS

FIG. 1 is a flow chart depicting the general functionality of an exemplary implementation of the method of the present invention;

FIG. 2 is a plot of an exemplary regression analysis for an initial subset of daily natural gas pipeline nominations data against the actual reported average quarterly gas production for a selected producer;

FIG. 3 is a flow chart depicting the application of the producer production model, which is the output from the flow chart of FIG. 1, to estimate production for a selected producer;

FIG. 4 is a plot of exemplary aggregated values of overall daily production activity within a chosen subset;

FIG. 5 is a plot of exemplary aggregated values of overall daily production activity;

FIG. 6 is a plot of modeled average quarterly gas production for a selected producer using daily natural gas pipeline nominations;

FIG. 7 is an exemplary map of oil wells owned and operated by a producer; and

FIG. 8 is a schematic representation of the core components in the exemplary implementation of FIG. 1.

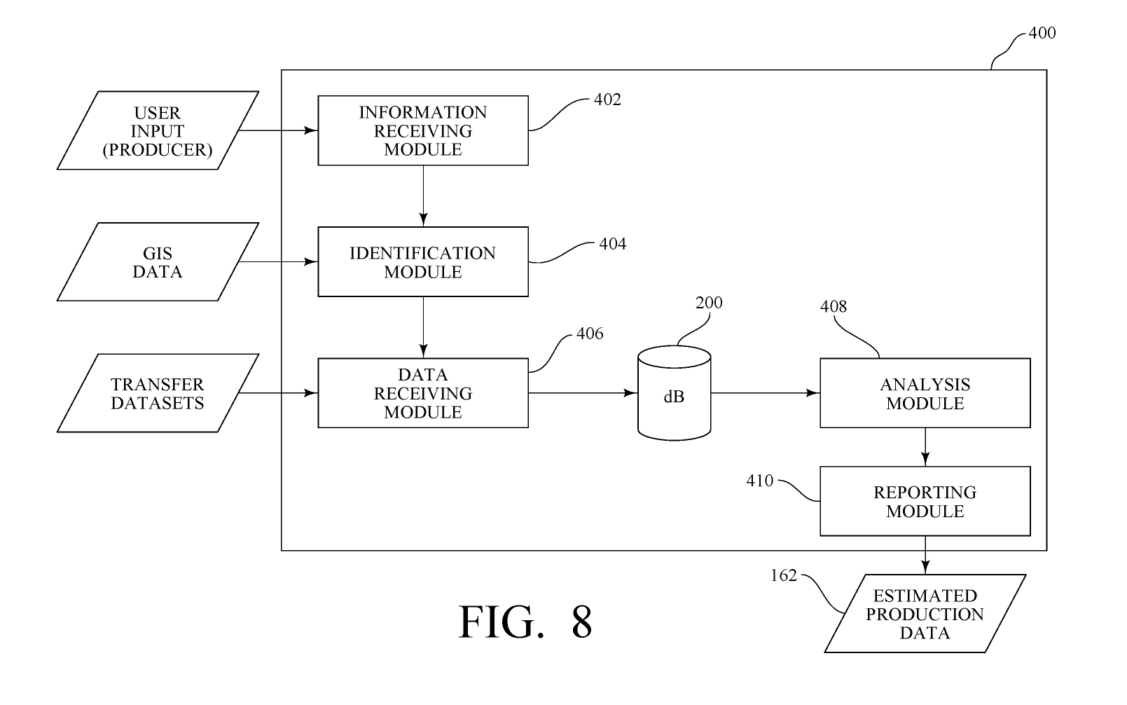

### DETAILED DESCRIPTION OF THE INVENTION

The present invention is a method for estimating (and forecasting) production of an energy commodity (such as crude oil or natural gas) by a selected producer based on an optimized model of commodity transfer activity for the same geographic region in which the production assets of the selected producer are located. Specifically, by methods of the present invention, crude oil or natural gas production for a selected producer can be estimated by choosing an optimized subset of crude oil or natural gas production data for a particular geographic region in which the selected producer owns or operates production assets, and then building a model calibrated to historical production data for that selected producer (i.e., a producer production model).

Furthermore, oil and gas occur in geologic formations with varying ratios of potentially producible oil and gas present in the rock. A particular geographic region may be primarily oil rich, primarily natural gas rich, or produce both oil and natural gas. In many geographic regions, strong inter-relationships exist between crude oil and natural gas production, and, in particular, crude oil production is strongly correlated with natural gas production. Natural gas production in this context can mean natural gas produced at the well-head, as well as natural gas and natural gas liquids resulting from upstream processing at natural gas processing facilities. In any event, through methods such as those described in commonly owned and co-pending U.S. patent application Ser. No. 14/971,088 (published as U.S. Patent Publication No. 2016/0180357), which is incorporated herein by reference, a correlation between crude oil production and natural gas production can be determined. Thus, natural gas production data can often be used not only to estimate and forecast natural gas production, but also to estimate and forecast crude oil production. Similarly, crude oil production data can often be used not only to estimate and forecast crude oil production, but also to estimate and forecast natural gas production.

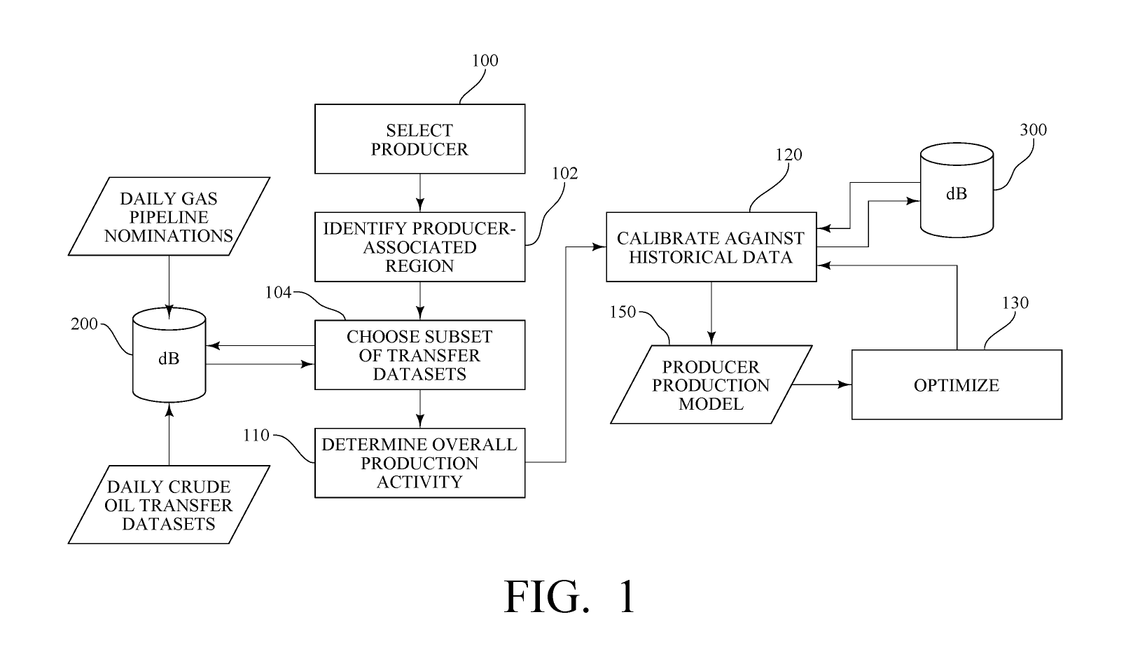

Referring now to FIG. 1, an exemplary implementation of the method of the present invention commences with the selection of a producer of interest, as indicated by block 100 of FIG. 1. Oil and gas producers are associated with a region (i.e., a producer-associated region) in which their oil or gas production assets are located or within multiple regions across which production assets are distributed. Once the producer has been selected, the producer-associated region (or regions) is identified, including an identification of transaction points within the producer-associated region, as indicated by block 102 of FIG. 1. This identification of a producer-associated region (or regions) can be carried out by automatically or manually associating certain production assets and infrastructure with specific producer owned or operated networks. For instance, producer-associated regions can be automatically or dynamically defined using a Geographical Information System (GIS), which uses physical location data (e.g., latitude and longitude co-ordinates) on crude oil and natural gas wells, pipelines, pipeline metering, and/or receipt and delivery points, as well as processing and storage facilities along pipelines. Each identified location may be referred to as a “transaction point,” and thus, the step of identifying the producer-associated region includes an identification of transaction points within the producer-associated region.

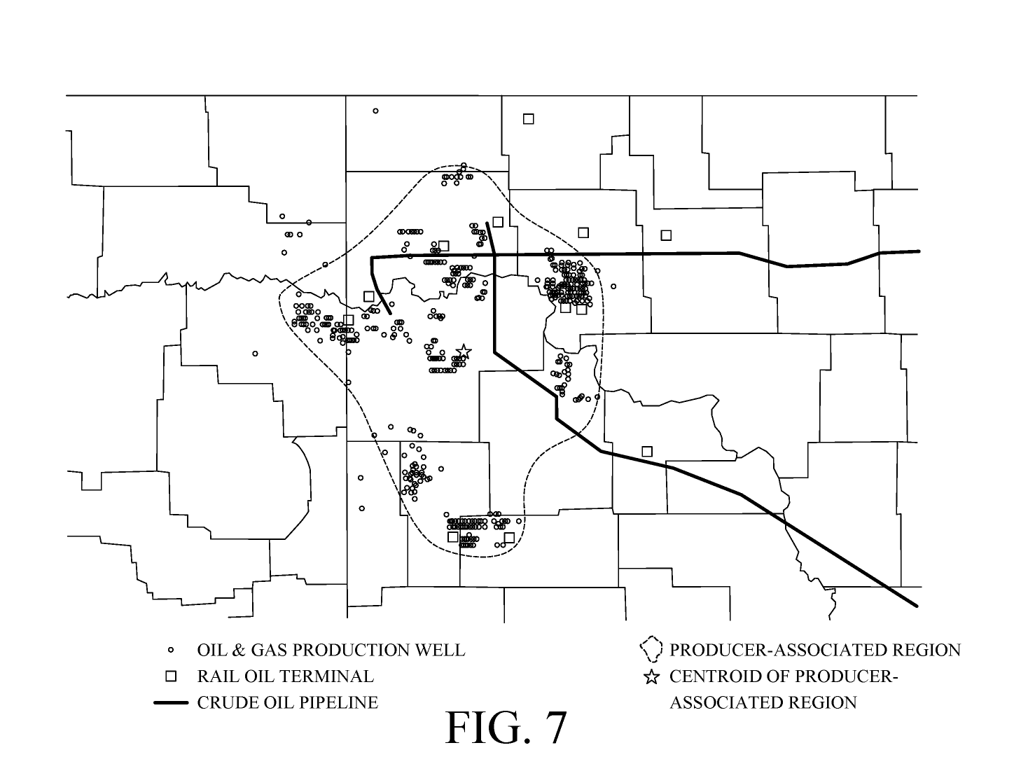

With respect to automatic identification of producer-associated regions, the locations of production assets of a particular producer are generally known. For instance, the location of actual wells owned or operated by a particular producer can be sourced using permits, remote imagery of the area, and/or other public information sources. What is less typically known is the exact infrastructure used to transfer the produced crude oil or natural gas from the production region to sites used for storage, processing, or for use by a third party. For instance, FIG. 7 is an exemplary map of oil wells owned and operated by a producer of interest. Thus, in one exemplary implementation, maps or other geo-location data sets of pipelines, rail lines, terminals and/or roads known to be used for the transfer of, in this case, crude oil can then be overlaid onto the map. In the case of a crude oil pipeline, the geo-coordinates can represent discrete points along the pipeline, such as the location of specific pumping stations, or contain continuous points (i.e., a polyline) defined in a GIS database of pipeline co-ordinates. In some cases where infrastructure is too new to have been mapped and available in publically available GIS databases, remotely acquired imagery (for example, imagery acquired by satellite or aerial means) can be used to identify the location of all pipelines in an area via computer-implemented image processing to isolate pipeline right-of-ways that are connected to the production assets of interest in a region (e.g., oil wells). Due to the nature of how pipelines are built for crude oil and natural gas, distinct right-of-ways are defined and are typically kept vegetation-free. This practice makes the identification and tracking of pipeline right-of-ways possible using standard image processing techniques to identify regions where vegetation is artificially removed to keep the right-of-ways clear. In any event, once the oil wells and other infrastructure have been mapped, a mathematical analysis can be applied to define the producer-associated region.

For example, the boundary for the producer-associated region may be calculated by mathematically optimizing a cost function that simultaneously minimizes the boundary perimeter for a candidate cluster of points, while maximizing the point density per unit area for the candidate cluster of points. Such a model can be further constrained to include a minimum fraction of the total number of points; for instance, the boundary can be constrained to include a predetermined percentage (e.g., at least 95%) of all of the candidate oil and natural gas wells (points) owned and/or operated by the producer of interest, which can be defined by an adjustable thresholding parameter. The adjustable thresholding parameter has the effect of excluding single points and small, low-density clusters which are farthest from the centroid of the producer-associated region. The result of this optimized boundary function is approximately represented by the dashed line labeled “Producer-Associated Region” in FIG. 7.

For another example, the boundary for the producer-associated region may be calculated by applying a mechanical “rubber-band” model, where straight lines are drawn around all the points that should be included in the producer-associated region to form a convex polygon containing all the desired points with straight-line boundaries. An adjustable thresholding parameter can then be applied to include a predetermined percentage (e.g., at least 95%) of the total points, rejecting the 5% of the outliers that are farthest from the centroid of the producer-associated region.

After a particular producer-associated region has been identified, and all available transaction points have been identified for the transfer of a commodity from the particular producer-associated region, a value for overall production activity (for example, crude oil production or natural gas pipeline production) for the region is determined from a subset of selected transfer datasets associated with the transaction points.

### Natural Gas Production

In the case of natural gas production, in one exemplary implementation, the subset of selected transfer datasets are comprised of daily natural gas pipeline nominations from a set of natural gas pipelines. Such nominations are not real-time measurements of physical natural gas flows. Rather, they are day-ahead contracted flows of physical gas to be delivered to transaction points in a pipeline network.

With respect to the selection of the daily natural gas pipeline nominations to be included in the subset, the objective is to select those nominations at specific transaction points that are most closely correlated with a producer's gas and/or oil production, as further discussed below. Transaction points can include, but are not limited to, points along a pipeline network associated with natural gas well-heads, natural gas storage facilities, natural gas pipeline meter and/or compressor stations, natural gas and natural gas liquid processing facilities, and other points whose cumulative data represents the balance of natural gas outbound from a particular geographic region or production area or facility strongly associated with an selected producer.

For instance, daily natural gas pipeline nominations can be scraped from natural gas operator postings published publicly on electronic bulletin boards. For example, the electronic bulletin board for the El Paso Natural Gas Company, L.L.C., a Kinder Morgan company, can be accessed at the following URL: http://passportebb.elpaso.com/ebbmasterpage/default.aspx?code=EPNG. Such daily natural gas pipeline nominations are preferably collected from many such electronic bulletin boards from multiple natural gas pipeline operators, and then stored in a database, as indicated by reference number 200 in FIG. 1.

Thus, in practice, as a starting point, an initial (or trial) subset of selected transfer datasets (i.e., daily natural gas pipeline nominations) within the particular producer-associated region is chosen from the selected daily natural gas pipeline nominations datasets stored in the database 200, as indicated by block 104 of FIG. 1. The methods for choosing and optimizing the final subset will be further described below, but the data in the subset is then summed or otherwise used to determine an aggregated value for overall production activity within the subset, as indicated by block 110 of FIG. 1.

Furthermore, in some embodiments, the daily values for production activity at the selected transaction points are then averaged together by month to produce a monthly value for overall production activity in the subset, or by quarter to produce a quarterly value for overall production activity in the subset.

For sake of example, Table 1 shows characteristic daily natural gas pipeline nominations data for a series of transaction points geographically or otherwise associated with selected producer. In this example, an initial subset of daily natural gas pipeline nominations data (at selected transaction points) is chosen (as indicated by a “YES” or “NO” logic value for Transaction Points 1-5) from among all available transaction points, and then for each day that data was collected, the daily natural gas pipelines nominations data is summed to determine an aggregated value for overall production activity within the subset for that day. Of course, in practice, a subset of arbitrary size is chosen from among hundreds of available transaction points for the selected producer of oil and gas in the producer-associated region.

TABLE 1

| | Included in subset? | | | | | | |
|---|---|---|---|---|---|---|---|
| | YES | NO | NO | YES | YES | | |
| | Transaction | Transaction | Transaction | Transaction | Transaction | . . . | Sum for |
| Date | Point 1 | Point 2 | Point 3 | Point 4 | Point 5 | . . . | subset |
| Oct. 1, 2014 | 1092 | 3000 | 55917 | 8 | 2533 | . . . | 10,150 |
| Oct. 2, 2014 | 1092 | 3000 | 56037 | 8 | 2490 | . . . | 10,069 |
| Oct. 3, 2014 | 0 | 3000 | 54109 | 8 | 0 | . . . | 10,043 |
| Oct. 4, 2014 | 0 | 3000 | 56546 | 8 | 0 | . . . | 11,048 |
| Oct. 5, 2014 | 0 | 3000 | 56546 | 8 | 0 | . . . | 11,054 |
| Oct. 6, 2014 | 0 | 3000 | 36203 | 8 | 0 | . . . | 11,050 |
| Oct. 7, 2014 | 0 | 3000 | 36203 | 8 | 0 | . . . | 11,047 |
| Oct. 8, 2014 | 160 | 3000 | 36203 | 8 | 0 | . . . | 11,070 |
| . . . | . . . | . . . | . . . | . . . | . . . | . . . | . . . |

Referring still to FIG. 1, the next step is to calibrate the aggregated values of overall production activity within the subset against publicly available historical production data, as indicated by block 120 of FIG. 1. Historical production data for the producer can be acquired from a number of different sources, including, for example, from the United States Securities & Exchange Commission (SEC) quarterly filings, and then stored in a database, as indicated by reference number 300 in FIG. 1. In most cases, historical production data is not immediately available, but is made available a few weeks or months after production and is commonly reported in terms of an average oil production value for each month (or quarter) in units of barrels per day for crude oil production and of million metric cubic feet per day (MMcfd) for gas production. In addition to public sources of producer data, production data may be available in certain circumstances from the producer directly or through direct producer monitoring using remote sensing technologies.

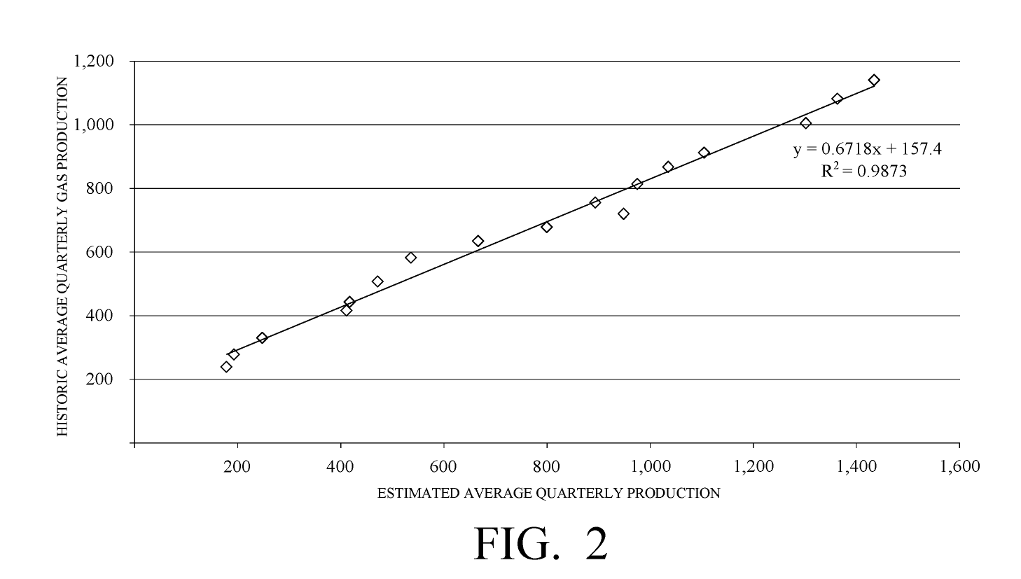

For example, to calibrate the aggregated values of overall production activity within the subset against historical production data, a linear regression analysis may be applied to the initial subset of daily natural gas pipeline nominations data (at selected transaction points) averaged over the quarter against the calibrating data of historical quarterly production. FIG. 2 is a plot of an exemplary regression analysis for the initial subset of daily natural gas pipeline nominations data chosen above, where the x-axis is the estimated average quarterly gas production for the selected producer based on the overall activity of the selected subset of transfer datasets in units of MMcfd, and the y-axis is the actual reported average quarterly gas production for the selected producer during the same time period in units of MMcfd. Each data point represents one quarter of data. Thus, the regression analysis results in a model for estimating the quarterly gas production for the selected producer based on historical production data, as indicated by output 150 in FIG. 1.

For another example, to calibrate the aggregated values of overall production activity within the subset against historical production data, a mathematical routine, such as Microsoft Excel® Solver, which iteratively optimizes which transfer data sets (at selected transaction points) are more closely correlated to historical production data for the selected producer, can be used.

As a further refinement, with respect to natural gas pipeline nominations, to optimize the model, a subset of daily natural gas pipeline nominations data can be chosen from the full daily natural gas pipeline nominations dataset that maximizes the value of the coefficient of determination, R², as indicated by block 130 of FIG. 1. Specifically, multiple subsets of daily natural gas pipeline nominations data are chosen from the full daily natural gas pipeline nominations dataset, and the above-described linear regression analysis is applied to each subset until the coefficient of determination, R², is maximized, and/or standard error of estimate (SEE) is minimized. Such an optimization routine thus selects those nominations at specific transaction points that are most closely correlated with a specific producer's published production data, while discarding the transaction points at which natural gas data and historical production data are poorly correlated. Alternatively, various weighting factors can be applied as user-inputted constants or dynamically-generated variables to different transaction points based on information derived from historical data analysis or real-time information on whether these transaction points will strongly or weakly correlate with producer data. Such transaction point weighting may also be affected by seasonal or transient effects, such as pipeline operations, weather, natural gas demand, market price, and localized pipeline construction and maintenance events. Of course, the model can also be periodically recalibrated and updated to reflect long-term changes in a producer network and infrastructure that affect the correlation between natural gas production activity and reported production by a producer. Triggers as to when model calibration and/or re-calibration needs to occur can be driven by any number of data mining or automated data learning techniques to detect patterns in the historic dataset which trigger changes in the definition and application of weighting factors or alert to changing dynamics in the physical network, e.g., when new pipelines come online or existing pipelines become fully loaded, causing flow congestion and limiting production flow-through into a region.

As an alternative, in another exemplary implementation, real-time measurements may be used. In other words, rather than daily natural gas pipeline nominations data (which is not based on real-time measurements of physical natural gas flows), the subset of selected transfer datasets would be comprised of measured natural gas flow data into and out of a particular geographic region. For example, U.S. Pat. No. 7,274,996 is entitled “Method and System for Monitoring Fluid Flow” and describes the measurement of acoustic waves to determine the flow rate of natural gas, crude oil, and/or other energy commodities. For another example, U.S. Pat. No. 7,376,522 is entitled “Method and System for Determining the Direction of Fluid Flow” and also relies on the measurement of acoustic waves to determine the direction of flow of natural gas, crude oil, and/or other energy commodities through a conduit. U.S. Pat. Nos. 7,274,996 and 7,376,522 are incorporated herein by reference.

As mentioned above, the natural gas pipeline nominations data (or measured natural gas flow data) can often be used not only to estimate and forecast natural gas production, but also to estimate and forecast crude oil production.

### Crude Oil Production

In the context of crude oil production, a value for overall production activity (which is based on crude oil transfer out of the identified region via pipeline, rail tanker car movements, or truck movements) is similarly determined from a subset of selected transfer datasets, which, in this case, are daily crude oil transfer datasets. Such daily crude oil transfer datasets are typically real-time measurements of physical crude oil flows or transfers by pipeline, rail, or truck. Such crude oil flows or transfers can be measured, for instance, by using certain sensing technologies. For example, U.S. Pat. No. 8,717,434, which is incorporated herein by reference, describes certain technology and methods for determining the amount and rate of flow of crude oil or other liquid energy commodities in selected pipelines in the particular network. For another example, U.S. patent application Ser. No. 15/040,754, which is also incorporated herein by reference, describes certain technology and methods for determining information about the flow of crude oil or other liquid energy commodities relative to a pipeline or other network component.

With respect to the selection of the daily crude oil transfer datasets to be included in the subset, the objective is to select those datasets at specific transaction points that are most closely correlated with a producer's oil production. Transaction points can include, but are not limited to, points along a pipeline network associated with crude oil well-heads, crude oil storage facilities, crude oil pipeline pumping stations, crude oil rail terminals, crude oil processing/refining facilities, and other points whose cumulative data represents the balance of crude oil outbound from a particular region.

Referring again to FIG. 1, in practice and as described above with respect to natural gas pipeline nominations data, as a starting point, an initial (or trial) subset of datasets within the particular producer-associated pipeline region is chosen from the daily crude oil transfer datasets stored in the database 200, as indicated by block 104 of FIG. 1. Again, the data in the subset is then summed or otherwise used to determine an aggregated value for overall production activity within the subset, as indicated by block 110 of FIG. 1.

Furthermore, as also described above with respect to natural gas pipeline nominations data, in some embodiments, the daily values for production activity at the selected transaction points are then averaged together by month to produce a monthly value for overall production activity in the subset, or by quarter to produce a quarterly value for overall production activity in the subset.

Referring again to FIG. 1, the next step is to calibrate the aggregated values of overall production activity within the subset against publicly available historical production data, as indicated by block 120 of FIG. 1. Again, historical production data for the producer can be acquired from a number of different sources, including, for example, from the United States Securities & Exchange Commission (SEC) quarterly filings, and then stored in a database, as indicated by reference number 300 in FIG. 1.

### Producer Production Model

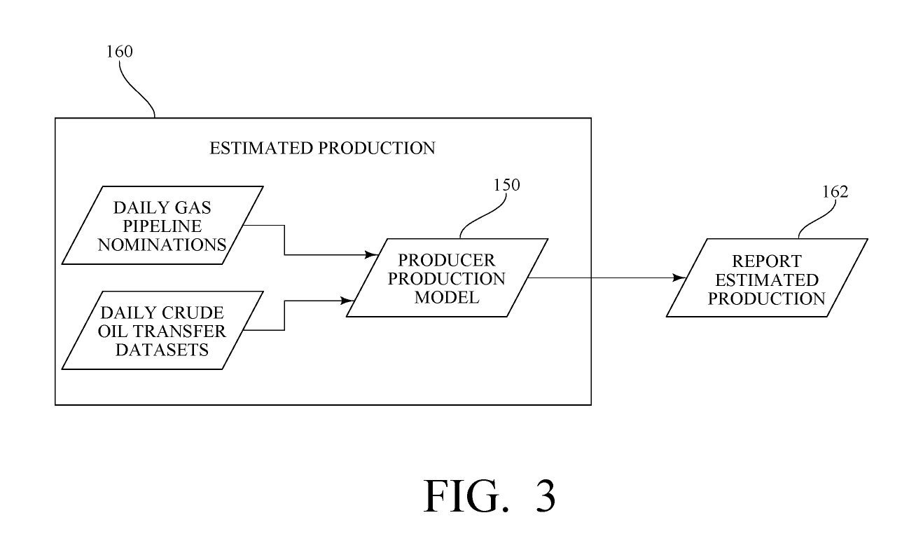

Referring now to FIG. 3, once the producer production model has been established and optimized for a producer, whether based on natural gas pipeline nominations or crude oil transfer datasets, the producer production model is then stored in a memory component of a computer, and, as natural gas pipeline nominations or crude oil transfer datasets are received for a particular day, those natural gas pipeline nominations or crude oil transfer datasets are input into the producer production model to estimate producer-specific production (e.g., gas and/or oil production), as indicated by block 160 in FIG. 3. The estimated production is then reported to market participants and other interested parties, e.g., third parties who would not ordinarily have ready access to such information, as indicated by block 162 in FIG. 3 in the form of daily, monthly, or quarterly production estimates, net production, and/or guidance data. It is contemplated and preferred that such reporting to market participants could be achieved through electronic mail delivery and/or through export of the data to an access-controlled Internet web site, which market participants can access through a common Internet browser program. Furthermore, as mentioned above, natural gas production data can often be used not only to estimate and forecast natural gas production, but also to estimate and forecast crude oil production. Similarly, crude oil production data can often be used not only to estimate and forecast crude oil production, but also to estimate and forecast natural gas production.

Furthermore, production data can be combined to allow a broader profile on any specific producer's equity and assets by incorporating third-party public data, such as hedging data and publicly reported open derivative positions, current and historical capital expenditure guidance, earnings call notes, and financial statement models. In particular, since the estimated production is based on daily (or substantially real-time) natural gas pipeline nominations or crude oil transfer datasets, a final estimate for a quarter is available a few weeks ahead of the publicly available company-published production data.

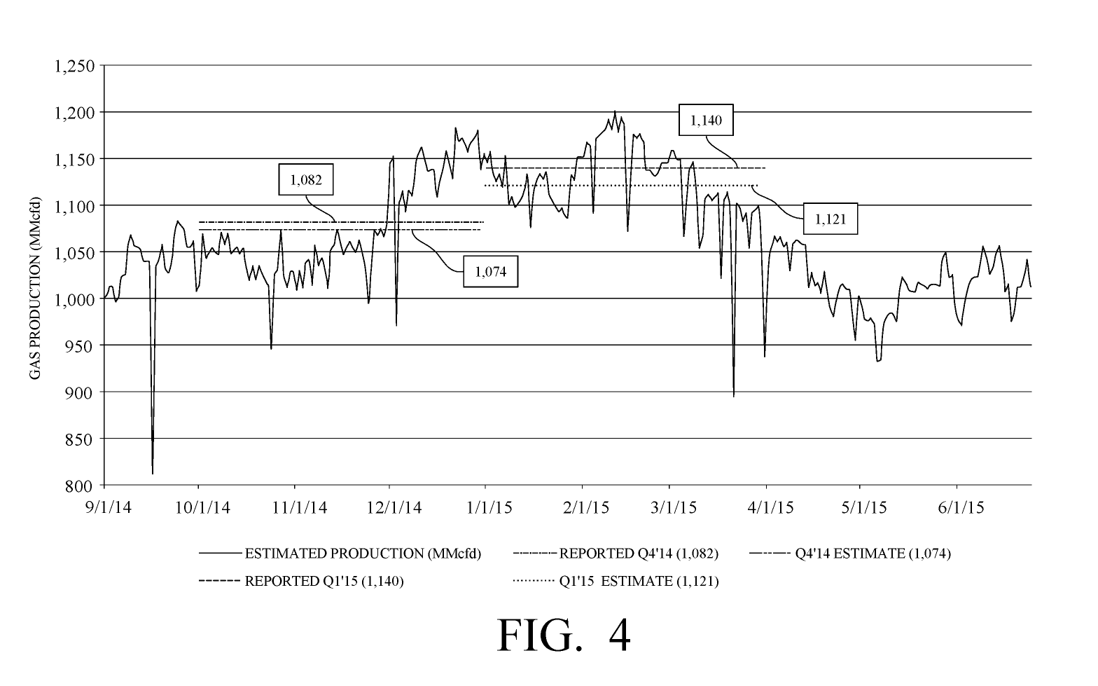

As a further illustration, FIG. 4 is a plot of exemplary aggregated values of overall daily production activity within a chosen subset in units of MMcfd (see block 110 of FIG. 1). Overlaying this plot are two pairs of horizontal lines which span one quarter for a selected producer, Company A. One line is “Q4′14 Estimate,” which has been determined using the optimized producer production model; see output 162 in FIG. 3. In this example, the estimate has a value of 1,074 MMcfd. The second line is “Reported Q4′14,” which is the actual value reported by Company A at a later date, for example, as included in Company A's SEC quarterly filings. In this example, the actual value is 1,082 MMcfd, a less than 1% deviation from the estimate. Similarly, for the first quarter of 2015, the estimated quarterly gas production for Company A was 1,121 MMcfd, and the actual reported average quarterly gas production for Company A was 1,140 MMcfd, which was a less than 1% deviation from the estimate.

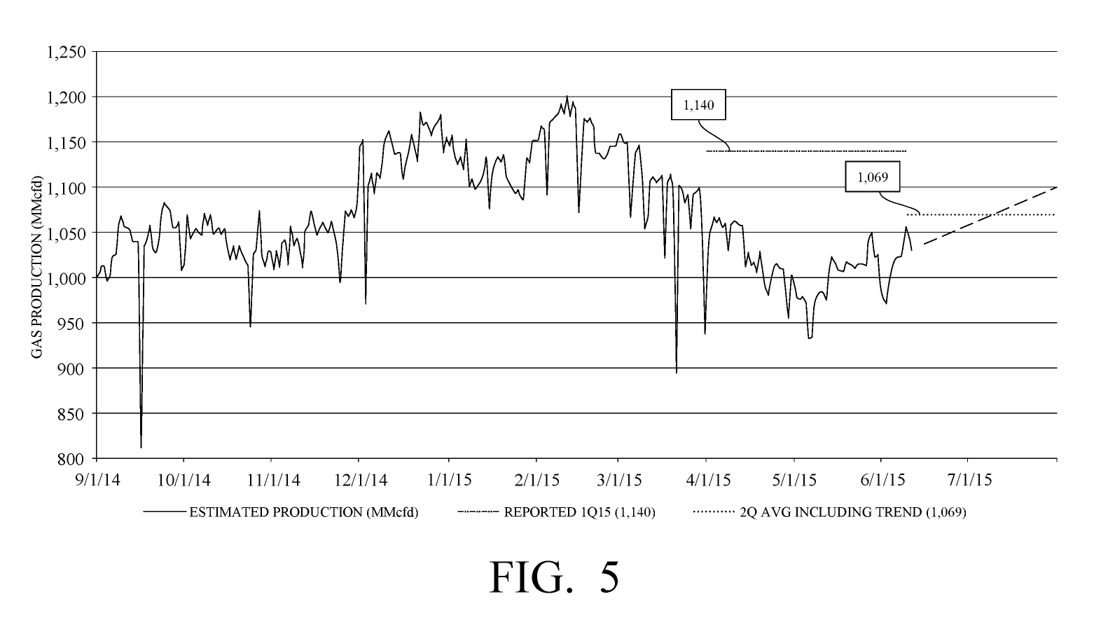

As a further refinement, and referring now to FIG. 5, which is a plot of exemplary aggregated values of overall daily production activity extending partially through the second quarter of 2015, trend analysis (e.g., the dotted trend line in FIG. 5) can be used to predict future daily values in overall production activity for the remainder of the quarter to provide estimates on average quarterly natural gas production well in advance of the end of the quarter.

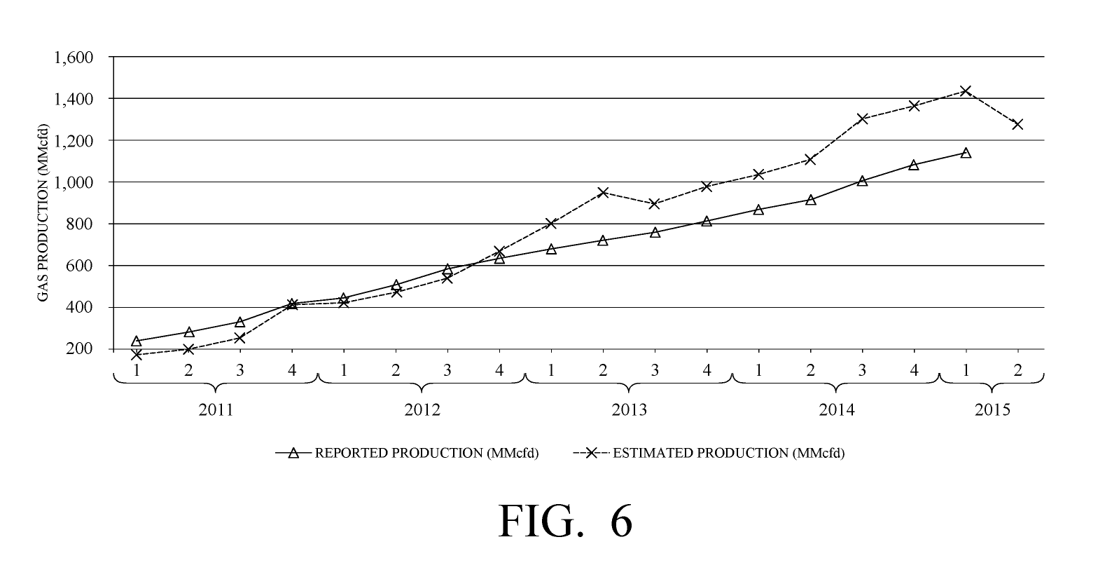

As a further illustration, FIG. 6 is a plot of the modeled average quarterly gas production data for a selected producer, Company A, using daily natural gas pipeline nominations. The model, which, as described above, is based on an optimized subset of daily natural gas pipeline nominations (at selected transaction points), is indicated by the dashed line, while the actual reported average quarterly gas production by Company A is indicated by the solid line for sake of comparison. Of course, as described above, the daily natural gas pipeline nominations allow for a daily estimate of gas production, while the actual reported gas production may not be available for weeks or months.

The above-described operational and computational steps of this method are preferably achieved through the use of a digital computer program (i.e., computer-readable instructions executed by a processor of a computer) that includes appropriate modules for executing the requisite instructions (which are stored in a memory component). Thus, an exemplary system 400 for estimating production of an energy commodity in accordance with the present invention includes: (a) an information receiving module 402 for receiving an input from a user as to a selection of a producer; (b) an identification module 404 for identifying a producer-associated region and transaction points within the producer-associated region, which, as described above, may receive and make use of GIS data; (c) a data receiving module 406 for receiving transfer datasets associated with the identified transaction points and storing those transfer datasets in the database 200; (d) an analysis module 408 for (i) choosing a subset of transfer datasets from the database, (ii) determining an aggregated value for overall production activity from the subset of transfer datasets for a predetermined time period, (iii) correlating the aggregated value for overall production activity for the predetermined time period against historical production data to establish a model for estimating production of the energy commodity by the producer, and (iv) applying the model to subsequently received transfer datasets for a particular time period to estimate production of the energy commodity by the producer for the particular time period; and (e) a reporting module 410 for reporting the estimated production of the energy commodity by the producer for the particular time period to a market participant.

It should be clear from the foregoing description that the method described above can be extended to any oil and/or gas producers for which both historical production data and daily natural gas pipeline nominations data or crude oil transfer datasets are available, including all oil and gas producers and producing basins in North America.

In addition to defining production regions in terms of specific producers or operators, such as areas containing wells associated with specific well owner-operators or areas servicing certain pipeline networks, certain regions can be defined as being associated with certain types of producer operations (e.g., natural gas producers, sour crude oil producers, sweet crude oil producers, etc.).

As a further refinement, by estimating and forecasting production for a selected producer in the above-described manner, it is possible to identify abnormalities, which can then trigger alerts to market participants. For instance, physical phenomena, such as weather events or infrastructure malfunction issues, can certainly impact energy commodity production networks. By estimating and forecasting production for a selected producer over a period of time, normal operating parameters can be identified. If some physical phenomena causes production estimates to deviate from those normal operating parameters, an alert can be promptly transmitted to market participants, for example, via electronic mail delivery.

As a further refinement, by estimating and forecasting production for a selected producer in the above-described manner, and factoring in market demand data associated with natural gas or crude oil from specific producers, it is also possible to forecast potential revenue losses for specific producers or potential price movements for energy commodities.

For example, an explosion in a segment of a major natural gas pipeline recently disrupted deliveries of natural gas in the United States. The method and system of the present invention would not only allow for an identification of a deviation from normal operating parameters as a result of this catastrophic event, but, based on the incoming natural gas pipeline nominations data, it would also allow for estimates of the lost production for one or more producers that rely on the disrupted pipeline. In addition to using the incoming natural gas pipeline nominations data to estimate loss of production, changes in operations resulting from and reacting to reduce production losses can be visualized and tracked during the event. For instance, incoming natural gas pipeline nominations data may indicate that natural gas flows are being diverted to other pipeline systems. Furthermore, depending on the type of event and analyzing data on past events of a similar nature, an estimate of how long the producer will be affected and the overall loss of production for the producer can also be estimated.

One of ordinary skill in the art will recognize that additional embodiments and implementations are also possible without departing from the teachings of the present invention. This detailed description, and particularly the specific details of the exemplary embodiments and implementations disclosed therein, is given primarily for clarity of understanding, and no unnecessary limitations are to be understood therefrom, for modifications will become obvious to those skilled in the art upon reading this disclosure and may be made without departing from the spirit or scope of the invention.

What is claimed is:

1. A method for estimating production of an energy commodity, comprising the steps of:
selecting a producer;
identifying a producer-associated region for the producer, including an identification of transaction points within the producer-associated region;
storing transfer datasets associated with the identified transaction points within the producer-associated region in a database;
choosing a subset of transfer datasets from the database;
determining an aggregated value for overall production activity from the subset of transfer datasets for a predetermined time period;
correlating the aggregated value for overall production activity for the predetermined time period against historical production data to establish a model for estimating production of the energy commodity by the producer;
subsequently receiving transfer datasets for a particular time period, and inputting those transfer datasets into the model to estimate production of the energy commodity by the producer for the particular time period; and
reporting the estimated production of the energy commodity by the producer for the particular time period to a market participant.

2. The method as recited in claim 1, wherein, in order to determine the aggregated value for overall production activity, data within the subset of transfer datasets is summed over the predetermined time period.

3. The method as recited in claim 1, wherein the energy commodity is natural gas.

4. The method as recited in claim 1, wherein the energy commodity is crude oil.

5. The method as recited in claim 1, in which the transfer datasets are comprised of daily natural gas pipeline nominations.

6. The method as recited in claim 1, in which the transfer datasets are comprised of measured natural gas flow data.

7. The method as recited in claim 1, in which the transfer datasets are comprised of daily crude oil transfer datasets.

8. A computer-implemented method for estimating production of an energy commodity, comprising the steps of:
selecting a producer;
identifying a producer-associated region for the producer, including an identification of transaction points within the producer-associated region;
storing transfer datasets associated with the identified transaction points within the producer-associated region in a database;
using a computer to choose a subset of transfer datasets from the database;
using the computer to sum data within the subset of transfer datasets to determine an aggregated value for overall production activity for a predetermined time period;
using the computer to correlate the aggregated value for overall production activity for the predetermined time period against historical production data to establish a model for estimating production of the energy commodity by the producer;
storing the model in a memory component of the computer;
using the computer to subsequently receive transfer datasets for a particular time period, and then to input those transfer datasets into the model stored in the memory component to estimate production of the energy commodity by the producer for the particular time period; and
reporting the estimated production to a market participant.

9. The method as recited in claim 8, wherein the energy commodity is natural gas.

10. The method as recited in claim 8, wherein the energy commodity is crude oil.

11. The method as recited in claim 8, in which the transfer datasets are comprised of daily natural gas pipeline nominations.

12. The method as recited in claim 8, in which the transfer datasets are comprised of measured natural gas flow data.

13. The method as recited in claim 8, in which the transfer datasets are comprised of daily crude oil transfer datasets.

14. A method for estimating production of an energy commodity by a selected producer, comprising the steps of:
identifying a producer-associated region for the selected producer, including an identification of transaction points within the producer-associated region;
storing daily natural gas pipeline nominations data associated with the identified transaction points within the producer-associated region in a database;
choosing a subset of daily natural gas pipeline nominations data from the database;
summing the daily natural gas pipeline nominations data within the subset to determine an aggregated value for overall daily production activity from the subset;
correlating the aggregated value for overall daily production activity against historical production data to establish a model for estimating production of the energy commodity by the selected producer;
subsequently receiving pipeline nominations data for a particular time period, and inputting those pipeline nominations data into the model to estimate production of the energy commodity by the selected producer for the particular time period; and
reporting the estimated production of the energy commodity by the selected producer for the particular time period to a market participant.

15. A method for estimating production of an energy commodity by a selected producer, comprising the steps of:
identifying a producer-associated region for the selected producer, including an identification of transaction points within the producer-associated region;
storing daily crude oil transfer datasets associated with the identified transaction points within the producer-associated region in a database;
choosing a subset of daily crude oil transfer datasets from the database;
summing the daily crude oil transfer datasets within the subset to determine an aggregated value for overall daily production activity from the subset;
correlating the aggregated value for overall daily production activity against historical production data to establish a model for estimating production of the energy commodity by the selected producer;
subsequently receiving crude oil transfer datasets for a particular time period, and inputting those crude oil transfer datasets into the model to estimate production of the energy commodity by the selected producer for the particular time period; and
reporting the estimated production of the energy commodity by the selected producer for the particular time period to a market participant.

16. A system for estimating production of an energy commodity, comprising:
an information receiving module for receiving an input from a user as to a selection of a producer;
an identification module for identifying a producer-associated region and transaction points within the producer-associated region;
a data receiving module for receiving transfer datasets associated with the transaction points and storing those transfer datasets in a database;
an analysis module for
(i) choosing a subset of transfer datasets from the database,
(ii) determining an aggregated value for overall production activity for a predetermined time period,
(iii) correlating the aggregated value for overall production activity for the predetermined time period against historical production data to establish a model for estimating production of the energy commodity by the producer, and
(iv) applying the model to subsequently received transfer datasets for a particular time period to estimate production of the energy commodity by the producer for the particular time period; and
a reporting module for reporting the estimated production of the energy commodity by the producer for the particular time period to a market participant.

17. The system as recited in claim wherein, in determining the aggregated value for overall production activity, data within the subset of transfer datasets is summed over the predetermined time period.

18. The system as recited in claim 16, wherein the energy commodity is natural gas.

19. The system as recited in claim 16, wherein the energy commodity is crude oil.

20. The system as recited in claim 16, in which the transfer datasets are comprised of daily natural gas pipeline nominations.

21. The system as recited in claim 16, in which the transfer datasets are comprised of measured natural gas flow data.

22. The system as recited in claim 16, in which the transfer datasets are comprised of daily crude oil transfer datasets.
